(19) United States
(12) Patent Application Publication
(10) Pub. No.: US 2025/0146346 A1
(43) Pub. Date: May 8, 2025

(54) VEHICLE WITH MULTIMODAL TRUNK LID

(71) Applicant: HELLA GmbH & Co. KGaA, Lippstadt (DE)

(72) Inventor: Sven-Erik WOLF, Lippstadt (DE)

(73) Assignee: HELLA GmbH & Co. KGaA, Lippstadt (DE)

(21) Appl. No.: 18/940,886

(22) Filed: Nov. 8, 2024

(30) Foreign Application Priority Data
Nov. 8, 2023 (DE) 10 2023 130 926.9

(51) Int. Cl. E05D 15/58; B62D 25/12

(52) U.S. Cl. CPC E05D 15/583; B62D 25/12; E05Y 2900/548

(57) ABSTRACT

A vehicle with a multimodal trunk lid. The multimodal trunk lid is mounted in a first mode of operation around a first pivot point located at one end of the multimodal trunk lid on a vehicle body in a way that it can be pivoted into a first open position. The multimodal trunk lid is also mounted on the vehicle body in a second mode of operation so that it can be moved translationally to a second open position.

This nonprovisional application claims priority under 35 U.S.C. § 119 (a) to German Patent Application No. 10 2023 130 926.9, which was filed in Germany on Nov. 8, 2023, and which is herein incorporated by reference.

### BACKGROUND OF THE INVENTION

### Field of the Invention

The invention relates to a vehicle with a multimodal trunk lid, i.e., with a trunk lid that has several operating modes.

### Description of the Background Art

Nowadays, trunk lids are usually pivoted via a first pivot point located at an upper end of the trunk lid, mounted on a vehicle body of the vehicle, and usually swing open far above the vehicle roof when adjusted to their open position. This can be problematic, for example, when parking inside a parking garage or a garage with a low ceiling, as the free end of the trunk lid can hit the ceiling in the open position, causing scratches to the trunk lid. Such trunk lids also swing out relatively far backward when opened, which can hinder opening in a narrow parking space or lead to the trunk lid hitting a neighboring vehicle or a wall. Access to the trunk is then not possible.

In addition, the opening process of the trunk lid can take a relatively long time, especially with electrically adjustable trunk lids. This results in a relatively long waiting time until the user gains access to the cargo floor of the trunk.

Modern vehicles often have a hidden cargo floor located below the primary cargo floor, which can be reached by lifting a floor hatch forming the primary cargo floor. For example, umbrellas or shopping bags, or in the case of an electric car, charging cables are stored there. However, access to the hidden cargo floor is quite cumbersome, as the floor hatch has to be lifted manually in known vehicles.

### SUMMARY OF THE INVENTION

It is therefore an object of the invention to provide a vehicle with an improved trunk lid, in particular with a more user-friendly trunk lid that provides easy and quick access to the trunk contents.

The vehicle according to an example of the invention comprises a multimodal trunk lid, wherein the multimodal trunk lid is mounted in a first mode of operation and can be pivoted into a first open position around a first pivot point located at one end of the trunk lid on a vehicle body, and wherein in a second mode of operation, the multimodal trunk lid is mounted on the vehicle body so as to be movable in a translational manner to a second open position.

The vehicle's multimodal trunk lid has two modes of operation and is multimodal in this sense. The two operating modes refer to different ways of opening the multimodal trunk lid.

In the first operating mode, the multimodal trunk lid is rotatably mounted on the vehicle body so as to be pivoted around a first pivot point. Such a movement allows for the multimodal trunk lid to reach the first open position. The first pivot point is at one end of the multimodal trunk lid, in particular at an upper end in the closed position of the multimodal trunk lid. In relation to the vehicle, the first pivot point is preferably located at an upper end of the rear of the vehicle body. The first pivot point can be on a first axis of rotation, with the first axis of rotation preferably extending horizontally along the upper end of the rear of the vehicle. In the first operating mode, the multimodal trunk lid is therefore preferably mounted on the vehicle body in a way that it can be swung upward. The first open position is therefore in particular an upward-swinging position of the multimodal trunk lid. The multimodal trunk lid can thus be opened in a known manner, i.e., it can be swung open from a closed position to the first open position.

In the second operating mode, the multimodal trunk lid is mounted on the vehicle body to be movable in a translational manner. The multimodal trunk lid is therefore mounted on the vehicle body differently in the second operating mode than in the first operating mode. The second open position differs from the first open position. While the multimodal trunk lid can be pivoted relative to the vehicle body in the first operating mode, i.e., can be moved rotationally, the multimodal trunk lid can be moved translationally relative to the vehicle body in the second operating mode. By means of the translational movement, the multimodal trunk lid is moved from the closed position to the second open position. In the second operating mode, the multimodal trunk lid can preferably be moved translationally upward into the second open position. Preferably, the multimodal trunk lid is not pivotally mounted around the first pivot point in the second operating mode. The translational movement can be realized in different ways, for example by means of a double-bearing joint, as will be explained below. For example, the multimodal trunk lid can be adjusted to the first open position by selecting the first operating mode using a vehicle remote control and to the second open position by selecting the second operating mode using the vehicle remote control.

In contrast to the trunk lids of known vehicles, the multimodal trunk lid according to the invention can not only be swung open to a first open position but can also be moved to a second open position different from the first open position by means of another movement. The multimodal trunk lid can be variably mounted or suspended on the vehicle for this purpose. The open positions can differ in terms of how far the multimodal trunk lid uncovers the trunk, for example partially or completely. For example, the multimodal trunk lid can be fully open in the first open position and only partially open in the second open position. Since a translational movement is carried out in the second operating mode, the movement of the multimodal trunk lid is less expansive than in the pivot movement in the first operating mode. In the second operating mode, the multimodal trunk lid preferably moves vertically upward relative to the vehicle body, while maintaining its orientation. This can enable the multimodal trunk lid to be opened even in a tight parking space without the multimodal trunk lid hitting a neighboring vehicle or wall. In the second operating mode, the multimodal trunk lid preferably extends less upward than in the first operating mode, which can prevent the multimodal trunk lid from hitting the ceiling above the vehicle. The trunk lid according to the invention is multimodal and more functional than known trunk lids. The vehicle may have damper elements and/or one or more electric actuators that drive the movement of the multimodal trunk lid.

The multimodal trunk lid can be designed to be moved in its entirety in the first operating mode as well as in the second operating mode. Accordingly, both in the first operating mode and in the second operating mode, it is not individual parts of the multimodal trunk lid that are relatively movable that are moved, but instead the multimodal trunk lid is moved in its entirety. In other words, when the multimodal trunk lid is adjusted to the first open position and the multimodal trunk lid is adjusted to the second open position, the same part of the multimodal trunk lid is moved, namely preferably the entire multimodal trunk lid. The multimodal trunk lid can be a one-piece trunk lid in particular. It may therefore be provided that the multimodal trunk lid does not have several sub-elements that are movable relative to each other but instead is formed of a single moving part. The multimodal trunk lid can therefore be more stable and of simpler construction than, for example, a two-part trunk lid with mutually movable sub-elements.

The multimodal trunk lid can be mounted on the vehicle via a pivot joint with a first suspension on the vehicle side and a second suspension on the trunk lid side, wherein the first suspension forms the first pivot point and the second suspension forms a second pivot point, and wherein the multimodal trunk lid in the second mode of operation can be moved translationally by a combined pivot of the multimodal trunk lid around the second pivot point and the pivot joint around the first pivot point. In other words, the vehicle includes a pivot joint by means of which the multimodal trunk lid is mounted on the vehicle body. In the second operating mode, the pivot joint is connected to the vehicle body via the first suspension and to the multimodal trunk lid via the second suspension. When the multimodal trunk lid is moved to the second open position, the pivot joint pivots around the first pivot point relative to the vehicle body. In addition, the pivot joint and the multimodal trunk lid pivot relative to each other around the second pivot point in such a way that the multimodal trunk lid is moved translationally. In particular, the multimodal trunk lid is adjusted vertically upward, preferably without changing its orientation relative to the vehicle body. In the second operating mode, the multimodal trunk lid is therefore particularly preferably not moved beyond the rear of the vehicle, or only to a small extent, in particular less far than in the first operating mode, so that it can also be opened in a narrow parking space. With this movement around two pivot points, the translational movement of the multimodal trunk lid in the second mode of operation, which is provided according to the invention, can be achieved in a structurally simple manner. In the first operating mode, on the other hand, preferably only the pivot movement around the first pivot point takes place, in particular a pivot movement of the multimodal trunk lid together with the pivot joint around the first pivot point.

Thus, the multimodal trunk lid is non-rotatably connected to the second suspension in the first operating mode, and the non-rotatable connection is released in the second operating mode. Non-rotatably connected means that the pivot movement of the multimodal trunk lid is blocked around the second pivot point located in the second suspension. This ensures that in the first operating mode, a pivoting of the multimodal trunk lid around the second pivot point is blocked and in the second operating mode, a pivot of the multimodal trunk lid around the second pivot point is permitted. Such a non-rotatable connection is achieved according to an example in that in the first operating mode, the end of the multimodal trunk lid is connected to the first suspension and in the second operating mode, a connection between the first suspension and the end of the multimodal trunk lid is released. In other words, in the first operating mode, the pivot joint is fixed on the multimodal trunk lid, so that the multimodal trunk lid and pivot joint move together around the first pivot point formed by the first suspension. In this state, the first pivot point can be understood as being located at an upper end of the multimodal trunk lid. In this way, it can be achieved that the multimodal trunk lid in the first operating mode pivots upward together with the pivot joint when adjusted to the first open position. In the second operating mode, the non-rotatable connection is released, so the multimodal trunk lid is no longer non-rotatably connected to the second suspension, in particular to the pivot joint. This releases the already described rotational movement of the multimodal trunk lid around the second pivot point. Thus, it can be achieved that the multimodal trunk lid in the second operating mode pivots around the second pivot point in the manner explained above, and thus relative to the pivot joint, while the pivot joint pivots around the vehicle-side first pivot point, which enables the translational movement of the multimodal trunk lid.

The vehicle body can have an extendable bearing element, which is located within the vehicle body in the first operating mode, and which extends upward from the vehicle body in the second operating mode, and at the end of which the first pivot point is arranged. The multimodal trunk lid is preferably connected to the bearing element via a first suspension that forms the first pivot point. With such a bearing element, as an alternative to the pivot joint explained above, the translational adjustability of the multimodal trunk lid can be realized in the second operating mode. In this example, preferably only the first pivot point is provided, but not the second pivot point. In the first operating mode, the bearing element remains in its retracted position, i.e., inside the vehicle body, and the multimodal trunk lid swings upward around the first pivot point when moving to the first open position. In the second operating mode, the bearing element moves upward out of the vehicle body, for example along a straight line (e.g., a vertical) or along a quarter-circle path, thus shifting the first pivot point upward. This means that the multimodal trunk lid connected to the bearing element is moved upward to the second open position via the first pivot point, i.e., in particular the first suspension. The multimodal trunk lid can pivot around the first pivot point relative to the bearing element, in particular in such a way that the multimodal trunk lid maintains its orientation relative to the vehicle body. It is therefore preferable that the multimodal trunk lid is not moved beyond the rear of the vehicle in the second operating mode, or only to a small extent, especially less far than in the first operating mode, so that it can also be opened in a narrow parking space. The movement of the bearing element can be carried out by an electric motor, for example. This example offers an alternative implementation of the two operating modes.

The multimodal trunk lid can be designed to assume a fully open position in the first open position and a partially open position in the second open position. In particular, the multimodal trunk lid can therefore assume a closed position, a fully open position in the first operating mode and a partially open position in the second operating mode. While full access to the trunk can be provided in the fully open position, only partial access to the trunk can be granted in the partially open position, for example. For example, a person standing in front of the trunk with the multimodal trunk lid partially open may have access to the part of the trunk closer to the trunk opening, but not to the part further back. In particular, access to a hidden cargo floor located below a cargo floor of the trunk can be made possible in order to remove items stored there, such as an umbrella, a shopping basket or, if it is an electric vehicle, a charging cable. The partially open position may be reached more quickly than the fully open position, allowing for faster access to at least part of the trunk in the second mode of operation. In addition, the multimodal trunk lid preferably cantilevers less far beyond the vehicle roof in the partially open position, so that the multimodal trunk lid can also be used in the second operating mode at low room heights, for example in a parking garage with a low ceiling.

The multimodal trunk lid can have a carrier, preferably located at a lower end of the multimodal trunk lid, which in the second operating mode is designed to engage in a floor hatch located in the trunk, so that the multimodal trunk lid takes the floor hatch with it when moving to the partially open position, thus uncovering a hidden cargo floor. The carrier is preferably a mechanical carrier, for example a hook. The floor hatch, for example, is a cargo floor of the trunk on which cargo can be placed. In the second operating mode, the multimodal trunk lid takes the floor hatch with it to the second open position via the carrier as it moves upward. As mentioned above, if the multimodal trunk lid is partially open, a person can be given access to a hidden cargo floor located below the floor hatch, that is to say, in particular the cargo floor, in order to remove items stored there, such as an umbrella, a shopping basket or, if it is an electric vehicle, a charging cable. Thanks to the carrier, in the second operating mode, the hidden cargo floor can be uncovered automatically when the multimodal trunk lid moves to the second open position, giving the person access to the hidden cargo floor without having to manually lift the floor hatch. The carrier is preferably designed in such a way that the carrier does not engage in the floor hatch when adjusting the multimodal trunk lid to the first open position, i.e., in the first operating mode. For example, the carrier can be designed in such a way that it does not engage in the floor hatch when the multimodal trunk lid is swung open to the second open position.

The carrier can be designed to be adjustable between a first position and a second position, wherein the carrier is recessed in the multimodal trunk lid in the first position and cantilevers from the multimodal trunk lid in the second position in order to engage in the floor hatch. For example, the carrier can be designed to be foldable and extendable. In the first position, i.e., the cantilevered or unfolded state, when adjusting the multimodal trunk lid to the second open position, the carrier engages the floor hatch in the manner explained above and takes it with it. In the second position, i.e., the recessed or folded state, the floor hatch is not engaged, so that the multimodal trunk lid can be adjusted to the second open position without having to take the floor hatch along. There can then be at least partial access to the cargo floor, i.e., to the actual trunk, as mentioned above. According to this example, the operator can themselves control, for example via a remote control, whether or not the hidden cargo floor should be uncovered in the second operating mode.

The floor hatch can have an extendable engagement element and the carrier is designed to engage in the extended engagement element in its second position to take the floor hatch with it. The engagement element can be designed to move between a retracted state and an extended state. According to this example, the carrier engages in the extended engagement element of the floor hatch in its cantilevered or unfolded state. This can facilitate the engagement of the carrier in the floor hatch and thus the lifting of the floor hatch by the multimodal trunk lid. In particular, together with the adjustable carrier, the carry along function explained above can be activated and deactivated.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIGS. 1a to 1c show three side views of a vehicle according to the invention with a multimodal trunk lid in different positions according to an example.

FIGS. 2a to 2c show two partial side views of the vehicle from FIG. 1 with a carrier arranged on the trunk lid for carrying along a floor hatch.

FIGS. 3a to 3c shows three side views of the vehicle according to the invention with a multimodal trunk lid in different positions according to an example.

### DETAILED DESCRIPTION

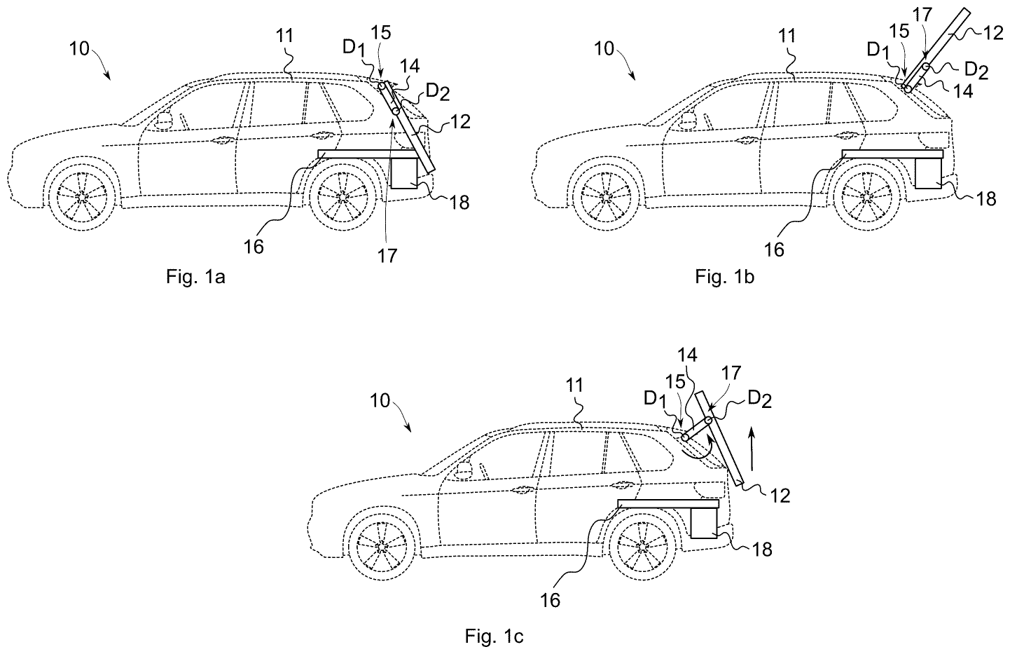

FIG. 1 shows an example of a vehicle 10 according to the invention. The vehicle 10 comprises a trunk with a cargo floor 16 for holding cargo, such as suitcases. Below the cargo floor 16 is a hidden cargo floor 18, i.e., an additional storage compartment. The cargo floor 16 forms a floor hatch covering the hidden cargo floor 18. The vehicle 10 also includes a multimodal, one-piece trunk lid 12, which can be opened in different ways in different operating modes.

In the example shown in FIG. 1, the multimodal trunk lid 12 is mounted on a vehicle body 11 of the vehicle 10 via a pivot joint 14 with a first suspension 15 on the vehicle side 15 and a second suspension 17 on the trunk lid side.

FIG. 1a shows the trunk lid 12 in a closed position. In a first operating mode, the trunk lid 12 can be swung open by a first pivot point D₁ from the closed position to a first open position shown in FIG. 1b. In this case, the trunk lid 12 is connected to the first suspension 15 of the pivot joint 14 or fixed to it in such a way that the trunk lid 12 can be pivoted around the first pivot point D₁ together with the pivot joint 14. The first pivot point D₁ can therefore be understood as being arranged at an upper end of the trunk lid 12. Thus, in the first operating mode, the trunk lid 12 is pivotally mounted around a first pivot point D₁ located at an upper end of the trunk lid 12 on the vehicle body 11 in a first open position. In this operating mode, the trunk lid 12 is non-rotatably connected to the second suspension 17, so that a second pivot point D₂ used in the second operating mode is non-functional.

As can be seen in FIG. 1b, the trunk lid 12 can thus be swung upward in the first operating mode. In this first open position, the trunk lid 12 is in a fully open position and allows for full access to the cargo floor 16 of the trunk. To gain access to the hidden cargo floor 18, a person can manually lift the cargo floor 16.

In a second operating mode, the trunk lid 12 is mounted on the vehicle body in a translational manner so as to be movable to a second open position shown in FIG. 1c. In this operating mode, the connection between the first suspension 15 and the trunk lid 12 is released. The trunk lid 12 is therefore no longer fixed to the first suspension 15 but can move freely from the first suspension 15. In addition, the non-rotatable connection between the trunk lid 12 and the second suspension 17 is released, so the trunk lid 12 can pivot around the second pivot point D₂. When adjusting the trunk lid 12 to the second open position, the pivot joint 14 pivots around the first pivot point D₁, as shown by a curved arrow in FIG. 1c. In addition, the pivot joint 14 pivots via the second pivot point D₂, relative to the trunk lid 12. This means that the trunk lid 12 can be moved translationally in the second operating mode by a combined pivot of the trunk lid 12 around the second pivot point D₂ and of the pivot joint 14 around the first pivot point D₁. It is preferable that the trunk lid 12 is moved vertically upward while maintaining its orientation relative to the vehicle body 11, as shown by the vertical arrow in FIG. 1c. In both the first and second operating modes, the trunk lid 12 is moved in its entirety, as shown in the figures.

While the trunk lid 12 assumes a fully open position in the first open position, see FIG. 1b, it assumes a partially open position in the second open position, see FIG. 1c. In the second open position, only partial access to the cargo floor 16 is thus guaranteed, which may nevertheless be sufficient to reach an object located at the rear end of the cargo floor 16. On the one hand, the second open position can be reached more quickly, as the trunk lid 12 only opens partially, which provides faster access to the trunk. On the other hand, the trunk lid 12 does not cantilever as far upward above the vehicle in the second open position as in the first open position, which can prevent the trunk lid 12 from hitting a ceiling above the vehicle 10. In addition, the translational movement of the trunk lid 12 to the rear in the second operating mode is less expansive than in the pivoting movement in the first operating mode, in particular if the trunk lid 12 moves vertically upward relative to the vehicle body 11 while maintaining its orientation. This can make it possible to open the trunk lid 12 even in a narrow parking space without the trunk lid hitting a second vehicle or a wall located at the rear behind the vehicle.

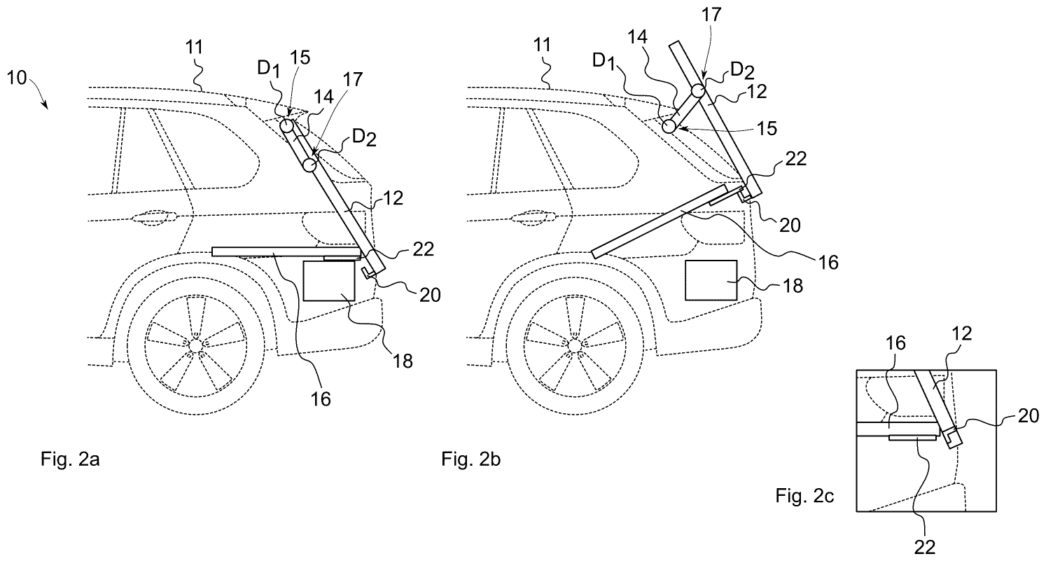

FIG. 2 again shows the vehicle 10 from FIG. 1 with the trunk lid 12 in the closed position (FIG. 2a) and in the second open position (FIG. 2b). In this example, the trunk lid 12 has a mechanical carrier 20 arranged on the inside at a lower end of the trunk lid 12 in the form of a hook. The carrier 20 is designed to be adjustable between a first position and a second position, wherein the carrier 20 is recessed in the trunk lid 12 in the first position, as can be seen in the detailed view in FIG. 2c, and in the second position cantilevers out of the trunk lid 12 in order to engage with the cargo floor 16, which forms a floor hatch, as depicted in FIGS. 2a, 2b. In addition, the cargo floor 16 has an extendable engagement element 22 on its underside, in which the carrier 20 engages in its second position to take the cargo floor 16 with it in the second operating mode. In FIG. 2b, the engagement element 22 is shown in its extended position, in FIGS. 2a and 2c in its retracted position.

In the closed position of the trunk lid 12 shown in FIG. 2a, the carrier 20 is recessed into the trunk lid 12 and the engagement element 22 is retracted into or under the cargo floor 16. If the carrier 20 and the engagement element 22 remain in these positions in the second operating mode of the trunk lid 12, i.e., during the translational opening movement, the trunk lid 12 opens without taking the cargo floor 16 with it, as shown in FIG. 1c. If, however, the carrier 20 is cantilevered and the engagement element 22 is extended, then during the translational movement of the trunk lid 12 in the second operating mode, the carrier 20 engages under the engagement element 22 during the opening process. The trunk lid 12 thus takes the cargo floor 16 with it when it moves into the second open position, i.e., lifts it, as shown in FIG. 2b.

This gives the user access to the hidden cargo floor 18 without the user having to lift the cargo floor 16 manually. The second operating mode can therefore be used to grant access to the hidden cargo floor 18, while the first operating mode is used to grant access to the cargo floor 16. When the trunk lid 12 is moved back to the closed position, the cargo floor 16 is set down again and thus closes the hidden cargo floor 18 or the volume of space formed by it. This function can be advantageous in electric cars, for example, if the user wants to have access to the charging cables located on the hidden cargo floor 18. This function can be deactivated for objects on the cargo floor 16, otherwise the objects could slip due to the inclined position of the cargo floor 16. For this purpose, the vehicle 10 may have a sensor, for example a force or resistance sensor, wherein a control unit stops the opening process if the cargo floor 16 is too resistant to the carry-along movement by the trunk lid 12. As an alternative to such a sensor, the control unit can, for example, assess a motor current of an electric actuator used to adjust the trunk lid 12 and stop the opening process if a limit value for the motor current is exceeded. This makes it unnecessary to provide separate sensors.

Preferably, the carrier 20, even if it is in the second position, does not engage with the engagement element 22 during the rotational movement of the trunk lid 12 in the open position in the first operating mode. There is then no need to fold in the carrier 20. In particular, it is only necessary to fold in the carrier 20 if the cargo floor 16 is not to be moved during the translational movement of the trunk lid 12, i.e., in the second operating mode.

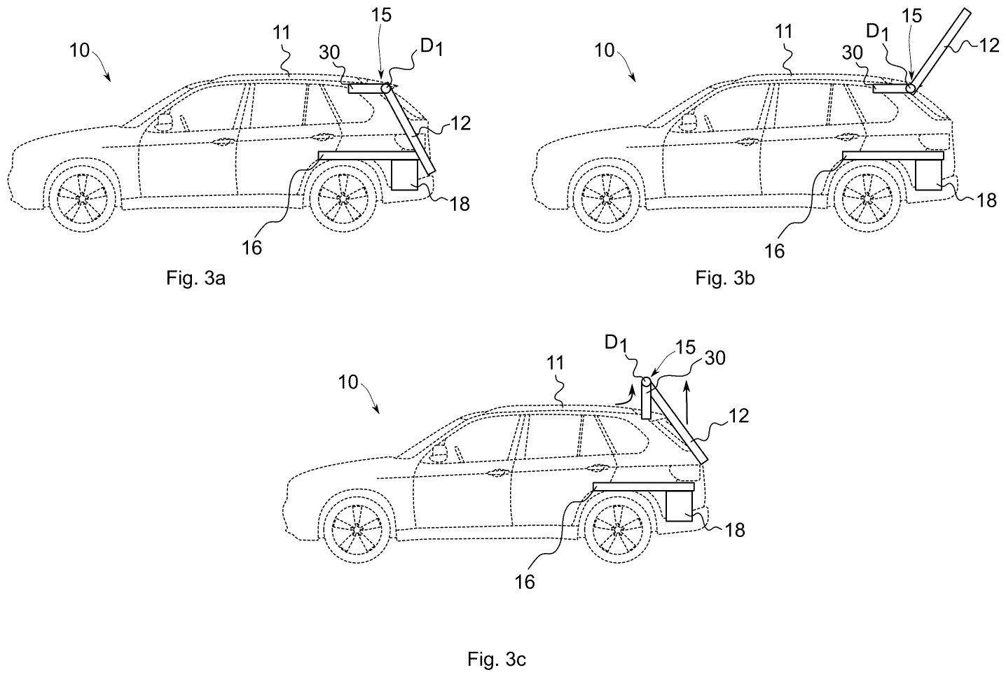

FIG. 3 shows an example of a vehicle 10 according to the invention, which has an extendable bearing element 30 instead of the pivot joint 14. The bearing element 30 is arranged in the first operating mode within the vehicle body 11, for example positioned horizontally, as shown in FIG. 3a. In this example, the trunk lid 12 is suspended from a first suspension 15 at the end of the bearing element 30 and is thus pivotally mounted in the first operating mode via a first pivot point D₁ located at the upper end of the trunk lid 12. In the second operating mode, the trunk lid 12 can be extended upward translationally by means of the bearing element 30.

FIG. 3a shows the trunk lid 12 in the closed position. In the first operating mode, the trunk lid 12 can be adjusted from the closed position to the first open position shown in FIG. 3b by pivoting the trunk lid 12 upward around the first pivot point D₁. In this case, the bearing element 30 remains in its retracted position in the vehicle body 11.

In the second mode of operation, the bearing element 30 extends upward, for example along a quarter-circle path shown by an arrow in FIG. 3c, and thus translationally brings the trunk lid 12 into its second open position, see FIG. 3c. The trunk lid 12 can pivot around the first pivot point D₁, which also extends upward, in such a way that the trunk lid 12 retains its orientation relative to the vehicle body 11.

Thus, even with the example of FIG. 3, the operating modes and open positions of the trunk lid 12 according to the invention can be achieved. This results in the advantages mentioned above. In particular, the trunk lid 12 in the second open position is also partially open in this example. The trunk lid 12 in this example can also have the carrier 20 described above and the cargo floor 16 can have the engagement element 22, so that automatic access to the hidden cargo floor 18 can be guaranteed.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A vehicle comprising:
a multimodal trunk lid; and
a first pivot point
wherein the multimodal trunk lid is mounted in a first mode of operation around the first pivot point on a vehicle body located at one end of the multimodal trunk lid in a way that it is pivoted into a first open position, and
wherein the multimodal trunk lid is mounted on the vehicle body in a second operating mode in a way that it is translationally moved into a second open position.

2. The vehicle according to claim 1, wherein the multimodal trunk lid is moved in its entirety in the first mode of operation as well as in the second mode of operation.

3. The vehicle according to claim 1, wherein the multimodal trunk lid is mounted on the vehicle via a pivot joint with a vehicle-side first suspension and a second suspension on the trunk lid side, wherein the first suspension forms the first pivot point and the second suspension forms a second pivot point, and wherein the multimodal trunk lid is moved translationally in the second operating mode by a combined pivoting of the multimodal trunk lid around the second pivot point and the pivot joint around the first pivot point.

4. The vehicle according to claim 3, wherein in the first mode of operation, the multimodal trunk lid is connected to the second suspension in a non-rotatable manner, and in the second mode of operation, the non-rotatable connection is released.

5. The vehicle according to claim 3, wherein in the first mode of operation, an end of the multimodal trunk lid is connected to the first suspension and in the second mode of operation, the connection between the first suspension and the upper end of the multimodal trunk lid is released.

6. The vehicle according to claim 1, wherein the vehicle body has an extendable bearing element that is arranged within the vehicle body in the first mode of operation and which extends upward from the vehicle body in the second mode of operation, and at the end of which the first pivot point is arranged.

7. The vehicle according to claim 1, wherein the multimodal trunk lid is designed to assume a fully open position in the first open position and a partially open position in the second open position.

8. The vehicle according to claim 1, wherein the multimodal trunk lid has a carrier arranged at a lower end of the multimodal trunk lid, which is designed to engage in a floor hatch located in the trunk in the second mode of operation, so that the multimodal trunk lid takes the floor hatch with it when moving to the partially opened position, thus uncovering a hidden cargo floor.

9. The vehicle according to claim 8, wherein the carrier is designed to be adjustable between a first position and a second position, wherein the carrier is recessed in the multimodal trunk lid in the first position and cantilevers from the multimodal trunk lid in the second position in order to engage in the floor hatch.

10. The vehicle according to claim 8, wherein the floor hatch has an extendable engagement element and the carrier is designed to engage with the extended engagement element in its second position in order to take the floor hatch with it.
